(19) United States
(12) Patent Application Publication
(10) Pub. No.: US 2002/0097780 A1
(43) Pub. Date: Jul. 25, 2002

(54) Preamble generation

(76) Inventors: Joseph P. Odenwalder, San Diego, CA (US); Sandip Sarkar, San Diego, CA (US); Jack Holtzman, San Diego, CA (US)

Correspondence Address: Qualcomm Incorporated, Patents Department, 5775 Morehouse Drive, San Diego, CA, 92121-1714, US

(21) Appl. No.: 09/727,924

(22) Filed: Nov. 30, 2000

(51) Int. Cl. H04K 1/00

(52) U.S. Cl. 375/146

(57) ABSTRACT

In a communication system wherein packetized data is transmitted to remote stations in a channel sensitive manner, a preamble must be transmitted with each discrete data transmission to the remote station. Method and apparatus are presented herein for generating an optimized preamble structure for use with transmissions of packetized data. An optimized preamble structure is one that is easily detectable and decodable, yet occupies a small fractional overhead of the entire transmission to the remote station. Information that needs to be carried by a preamble are used to create a basic structural unit, which is then redundantly permuted.

### BACKGROUND

I. Field

The present invention relates to wireless voice and data communication systems. More particularly, the present invention relates to novel and improved methods and apparatus for generating optimized preambles for data packets.

II. Background

The field of wireless communications has many applications including, e.g., cordless telephones, paging, wireless local loops, personal digital assistants (PDAs), Internet telephony, and satellite communication systems. A particularly important application is cellular telephone systems for mobile subscribers. (As used herein, the term “cellular” systems encompasses both cellular and personal communications services (PCS) frequencies.) Various over-the-air interfaces have been developed for such cellular telephone systems including, e.g., frequency division multiple access (FDMA), time division multiple access (TDMA), and code division multiple access (CDMA). In connection therewith, various domestic and international standards have been established including, e.g., Advanced Mobile Phone Service (AMPS), Global System for Mobile (GSM), and Interim Standard 95 (IS-95). In particular, IS-95 and its derivatives, IS-95A, IS-95B, ANSI J-STD-008 (often referred to collectively herein as IS-95), and proposed high-data-rate systems for data, etc. are promulgated by the Telecommunication Industry Association (TIA) and other well known standards bodies.

Cellular telephone systems configured in accordance with the use of the IS-95 standard employ CDMA signal processing techniques to provide highly efficient and robust cellular telephone service. Exemplary cellular telephone systems configured substantially in accordance with the use of the IS-95 standard are described in U.S. Pat. Nos. 5,103,459 and 4,901,307, which are assigned to the assignee of the present invention and fully incorporated herein by reference. In CDMA systems, over-the-air power control is a vital issue. An exemplary method of power control in a CDMA system is described in U.S. Pat. No. 5,056,109, which is assigned to the assignee of the present invention and fully incorporated herein by reference.

A primary benefit of using a CDMA over-the-air interface is that communications are conducted over the same radio frequency (RF) band. For example, each remote subscriber unit (e.g., a cellular telephone, personal digital assistant (PDA), laptop connected to a cellular telephone, hands-free car kit, etc.) in a given cellular telephone system can communicate with the same base station by transmitting a reverse-link signal over the same 1.25 MHz of RF spectrum. Similarly, each base station in such a system can communicate with remote units by transmitting a forward-link signal over another 1.25 MHz of RF spectrum. Transmitting signals over the same RF spectrum provides various benefits including, e.g., an increase in the frequency reuse of a cellular telephone system and the ability to conduct soft handoff between two or more base stations. Increased frequency reuse allows a greater number of calls to be conducted over a given amount of spectrum. Soft handoff is a robust method of transitioning a remote station from the coverage area of two or more base stations that involves simultaneously interfacing with two base stations. In contrast, hard handoff involves terminating the interface with a first base station before establishing the interface with a second base station. An exemplary method of performing soft handoff is described in U.S. Pat. No. 5,267,261, which is assigned to the assignee of the present invention and fully incorporated herein by reference.

In conventional cellular telephone systems, a public switched telephone network (PSTN) (typically a telephone company) and a mobile switching center (MSC) communicate with one or more base station controllers (BSCs) over standardized E1 and/or T1 telephone lines (hereinafter referred to as E1/T1 lines). The BSCs communicate with base station transceiver subsystems (BTSs) (also referred to as either base stations or cell sites), and with each other, over a backhaul comprising E1/T1 lines. The BTSs communicate with remote units via RF signals sent over the air.

To provide increased capacity, the International Telecommunications Union recently requested the submission of proposed methods for providing high-rate data and high-quality speech services over wireless communication channels. The submissions describe so-called “third generation,” or “3G,” systems. An exemplary proposal, the cdma2000 ITU-R Radio Transmission Technology (RTT) Candidate Submission (referred to herein as cdma2000), was issued by the TIA. The standard for cdma2000 is given in draft versions of IS-2000 and has been approved by the TIA. The cdma2000 proposal is compatible with IS-95 systems in many ways. Another CDMA standard is the W-CDMA standard, as embodied in 3^{rd} Generation Partnership Project “3GPP”, Document Nos. 3G TS 25.211, 3G TS 25.212, 3G TS 25.213, and 3G TS 25.214.

Given the growing demand for wireless data applications, the need for very efficient wireless data communication systems has become increasingly significant. The IS-95, cdma2000, and WCDMA standards are capable of transmitting both data traffic and voice traffic over the forward and reverse links. A method for transmitting data traffic in code channel frames of fixed size is described in detail in U.S. Pat. No. 5,504,773, entitled “METHOD AND APPARATUS FOR THE FORMATTING OF DATA FOR TRANSMISSION,” assigned to the assignee of the present invention and incorporated by reference herein.

A significant difference between voice traffic services and data traffic services is the fact that the former imposes stringent maximum delay requirements. Typically, the overall one-way delay of speech traffic frames must be less than 100 msec. In contrast, the delay of data traffic frames can be permitted to vary in order to optimize the efficiency of the data communication system. Specifically, more efficient error correcting coding techniques, which require significantly larger delays than those that can be tolerated by voice traffic services, can be utilized. An exemplary efficient coding scheme for data is disclosed in U.S. patent application Ser. No. 08/743,688, entitled “SOFT DECISION OUTPUT DECODER FOR DECODING CONVOLUTIONALLY ENCODED CODEWORDS,” filed Nov. 6, 1996, assigned to the assignee of the present invention and incorporated by reference herein.

Another significant difference between voice traffic and data traffic is that voice traffic requires a fixed and common grade of service (GOS) for all users. Typically, for digital systems providing voice traffic services, this translates into a fixed and equal transmission rate for all users and a maximum tolerable error rate for the speech traffic frames. In contrast, because of the availability of retransmission protocols for data traffic services, the GOS can be different from user to user and can be varied in order to increase the overall efficiency of the data communication system. The GOS of a data traffic communication system is typically defined as the total delay incurred in the transfer of a predetermined amount of data.

Various protocols exist for transmitting packetized traffic over packet-switching networks so that information arrives at its intended destination. One such protocol is “The Internet Protocol,” RFC 791 (September, 1981). The internet protocol (IP) breaks up messages into packets, routes the packets from a sender to a destination, and reassembles the packets into the original messages at the destination. The IP protocol requires that each data packet begins with an IP header containing source and destination address fields that uniquely identifies host and destination computers. The transmission control protocol (TCP), promulgated in RFC 793 (September, 1981), is responsible for the reliable, in-order delivery of data from one application to another. The User Datagram Protocol (UDP) is a simpler protocol that is useful when the reliability mechanisms of TCP are not necessary. For voice traffic services over IP, the reliability mechanisms of TCP are not necessary because retransmission of voice packets is ineffective due to delay constraints. Hence, UDP is usually used to transmit voice traffic.

Due to increasing consumer demand for data traffic services on wireless communication systems, there is a need to increase data traffic capacity in wireless communication systems. One way to increase data traffic capacity is to optimize the timing strategies used to transmit packets of data traffic.

### SUMMARY

Novel and improved methods and apparatus for generating easily detectable and decodable preambles are presented. A channel, as used herein, refers to at least a portion of the frequency bandwidth assigned to a wireless communication service provider. In the embodiments described below, the channel may be dedicated to both voice traffic and data traffic or the channel may be dedicated solely to data traffic.

In one aspect, a method for transmitting data packets in a wireless communication system in a channel sensitive manner is presented, the method comprising: repackaging a data payload into at least one subpacket; generating at least one preamble payload, wherein the at least one preamble payload corresponds to the at least one subpacket; and spreading the at least one preamble payload to form at least one preamble unit.

In another aspect, a method for optimizing the transmission of a data payload on a wireless communication system is presented, the method comprising: choosing an initial number of subpackets, wherein each subpacket will carry a substantially similar copy of the data payload; determining a data rate corresponding to the initial number of subpackets; determining a length for a preamble package in accordance with the data rate; determining a fractional overhead, wherein the length of the preamble package is compared to the bits of the subpackets; if the fractional overhead is greater than a predetermined threshold amount, then choosing a new number of subpackets; and if the fractional overhead is less than or equal to the predetermined threshold amount, then generating the preamble package.

In another aspect, a method for optimizing transmission of a data payload is presented, the method comprising: determining a data rate for the transmission of the data payload; and using a look-up table to determine a corresponding packet size for the data payload and a preamble length, wherein the packet includes at least one subpacket and a preamble is attached to each of the at least one subpacket.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a diagram of an exemplary data communication system;

FIG. 2 is a graph illustrating periodic transmissions of data traffic packets;

FIG. 3 is a graph illustrating transmission of data traffic packets during optimal transmission conditions;

FIG. 4 is a block diagram of an apparatus for generating a preamble unit and a preamble package;

FIG. 5 is a block diagram of an apparatus for generating a preamble unit, wherein a remote station identifier is encoded separately; and

FIG. 6 is a flowchart illustrating the determination of subpacket preamble lengths.

### DETAILED DESCRIPTION OF THE PREFERRED EMBODIMENTS

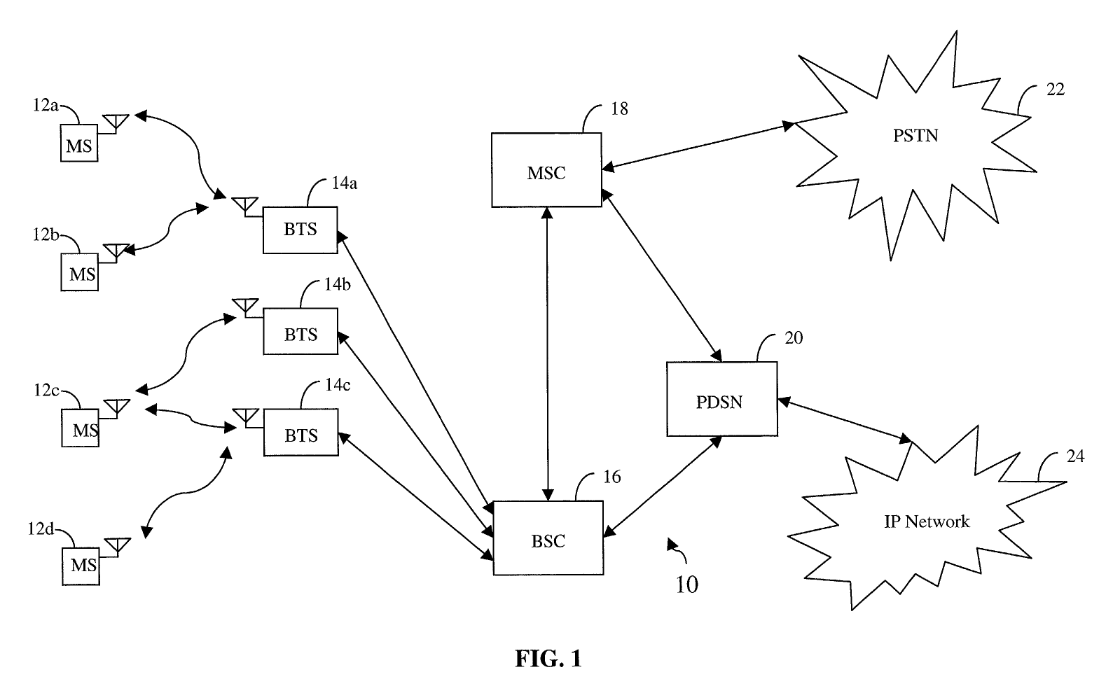

As illustrated in FIG. 1, a wireless communication network 10 generally includes a plurality of mobile stations or remote subscriber units 12a-12d, a plurality of base stations 14a-14c, a base station controller (BSC) or packet control function 16, a mobile station controller (MSC) or switch 18, a packet data serving node (PDSN) or internetworking function (IWF) 20, a public switched telephone network (PSTN) 22 (typically a telephone company), and an Internet Protocol (IP) network 18 (typically the Internet). For purposes of simplicity, four remote stations 12a-12d, three base stations 14a-14c, one BSC 16, one MSC 18, and one PDSN 20 are shown. It would be understood by those skilled in the art that there could be any number of remote stations 12, base stations 14, BSCs 16, MSCs 18, and PDSNs 20.

In one embodiment, the wireless communication network 10 is a packet data services network. The remote stations 12a-12d may be cellular telephones, cellular telephones connected to laptop computers running IP-based, Web-browser applications, cellular telephones with associated hands-free car kits, or PDAs running IP-based, Web-browser applications. The remote stations 12a-12d may advantageously be configured to perform one or more wireless packet data protocols such as described in, e.g., the EIA/TIA/IS-707 standard. In a particular embodiment, the remote stations 12a-12d generate IP packets destined for the IP network 24 and encapsulate the IP packets into frames using a point-to-point protocol (PPP).

In one embodiment, the IP network 24 is coupled to the PDSN 20, the PDSN 20 is coupled to the MSC 18, the MSC is coupled to the BSC 16 and the PSTN 22, and the BSC 16 is coupled to the base stations 14a-14c via wirelines configured for transmission of voice and/or data packets in accordance with any of several known protocols including, e.g., E1, T1, Asynchronous Transfer Mode (ATM), IP, PPP, Frame Relay, HDSL, ADSL, or xDSL. In an alternate embodiment, the BSC 16 is coupled directly to the PDSN 20, and the MSC 18 is not coupled to the PDSN 20. In one embodiment the remote stations 12a-12d communicate with the base stations 14a-14c over an RF interface defined in 3^{rd} Generation Partnership Project 2 “3GPP2”, “Physical Layer Standard for cdma2000 Spread Spectrum Systems,” 3GPP2 Document No. C.P0002-A, TIA PN-4694, to be published as TIA/EIA/IS-2000-2-A, (Draft, edit version 30) (Nov. 19, 1999), which is fully incorporated herein by reference.

During typical operation of the wireless communication network 10, the base stations 14a-14c receive and demodulate sets of reverse-link signals from various remote stations 12a-12d engaged in telephone calls, Web browsing, or other data communications. Each reverse-link signal received by a given base station 14a-14c is processed within that base station 14a-14c. Each base station 14a-14c may communicate with a plurality of remote stations 12a-12d by modulating and transmitting sets of forward-link signals to the remote stations 12a-12d. For example, the base station 14a communicates with first and second remote stations 12a, 12b simultaneously, and the base station 14c communicates with third and fourth remote stations 12c, 12d simultaneously. The resulting packets are forwarded to the BSC 16, which provides call resource allocation and mobility management functionality including the orchestration of soft handoffs of a call for a particular remote station 12a-12d from one base station 14a-14c to another base station 14a-14c. For example, a remote station 12c is communicating with two base stations 14b, 14c simultaneously. Eventually, when the remote station 12c moves far enough away from one of the base stations 14c, the call will be handed off to the other base station 14b.

If the transmission is a conventional telephone call, the BSC 16 will route the received data to the MSC 18, which provides additional routing services for interface with the PSTN 22. If the transmission is a packet-based transmission such as a data call destined for the IP network 24, the MSC 18 will route the data packets to the PDSN 20, which will send the packets to the IP network 24. Alternatively, the BSC 16 will route the packets directly to the PDSN 20, which sends the packets to the IP network 24.

Reverse channels are transmissions from remote stations 12a-12d to base stations 14a-14c. Performance of reverse link transmissions can be measured as a ratio between the energy levels of the pilot channel and other reverse traffic channels. A pilot channel accompanies the traffic channels in order to provide coherent demodulation of the received traffic channels. In the cdma2000 system, the reverse traffic channels can comprise multiple channels, including but not limited to an Access Channel, an Enhanced Access Channel, a Reverse Common Control Channel, a Reverse Dedicated Control Channel, a Reverse Fundamental Channel, a Reverse Supplemental Channel, and a Reverse Supplemental Code Channel, as specified by radio configurations of each individual subscriber network using cdma2000.

Although the signals transmitted by different remote stations within the range of a base station are not orthogonal, the different channels transmitted by a given remote station are mutually orthogonal by the use of orthogonal Walsh Codes. Each channel is first spread using a Walsh code, which provides for channelization and for resistance to phase errors in the receiver.

As mentioned previously, power control is a vital issue in CDMA systems. In a typical CDMA system, a base station punctures power control bits into transmissions transmitted to each remote station within the range of the base station. Using the power control bits, a remote station can advantageously adjust the signal strength of its transmissions so that power consumption and interference with other remote stations may be reduced. In this manner, the power of each individual remote station in the range of a base station is approximately the same, which allows for maximum system capacity. The remote stations are provided with at least two means for output power adjustment. One is an open loop power control process performed by the remote station and another is a closed loop correction process involving both the remote station and the base station.

However, on the forward link, a base station can transmit at a maximum power transmission level to all remote stations within the range of the base station because the issue of interference between remote stations within the same cell does not arise. This capability can be exploited to design a system that can carry both voice traffic and data traffic. It should be noted that the maximum power transmission level cannot be so high as to interfere with the operation of neighboring base stations.

In a system using variable rate encoding and decoding of voice traffic, a base station will not transmit voice traffic at a constant power level. The use of variable rate encoding and decoding converts speech characteristics into voice frames that are optimally encoded at variable rates. In an exemplary CDMA system, these rates are full rate, half rate, quarter rate, and eighth rate. These encoded voice frames can then be transmitted at different power levels, which will achieve a desired target frame error rate (FER) if the system is designed correctly. For example, if the data rate is less than the maximum data rate capacity of the system, data bits can be packed into a frame redundantly. If such a redundant packing occurs, power consumption and interference to other remote stations may be reduced because the process of soft combining at the receiver allows the recovery of corrupted bits. The use of variable rate encoding and decoding is described in detail in U.S. Pat. No. 5,414,796, entitled “VARIABLE RATE VOCODER,” assigned to the assignee of the present invention and incorporated by reference herein. Since the transmission of voice traffic frames does not necessarily utilize the maximum power levels at which the base station may transmit, packetized data traffic can be transmitted using the residual power.

Hence, if a voice frame is transmitted at a given instant x(t) at X dB but the base station has a maximum transmission capacity of Y dB, then there is (Y−X) dB residual power that can be used to transmit data traffic.

The process of transmitting data traffic with voice traffic can be problematic. Since the voice traffic frames are transmitted at different transmission power levels, the quantity (Y−X) db is unpredictable. One method for dealing with this uncertainty is to repackage data traffic payloads into repetitious and redundant subpackets. Through the process of soft combining, wherein one corrupted subpacket is combined with another corrupted subpacket, the transmission of repetitious and redundant subpackets can produce optimal data transmission rates.

For illustrative purposes only, the nomenclature of the cdma2000 system is used herein. Such use is not intended to limit the implementation of the invention to cdma2000 systems. In an exemplary CDMA system, data traffic can be transported in packets, which are composed of subpackets, which occupy slots. Slot sizes have been designated as 1.25 ms, but it should be understood that slot sizes may vary in the embodiments described herein without affecting the scope of the embodiments.

For example, if a remote station requests the transmission of data at 76.8 kbps, but the base station knows that this transmission rate is not possible at the requested time, due to the location of the remote station and the amount of residual power available, the base station can package the data into multiple subpackets, which are transmitted at the lower available residual power level. The remote station will receive the data subpackets with corrupted bits, but can soft combine the uncorrupted bits of the subpackets to receive the data payload within an acceptable FER.

In this method, the remote stations must be able to detect and decode the additional subpackets. Since the additional subpackets carry redundant data payload bits, the transmission of these additional subpackets will be referred to alternatively as “retransmissions.”

One method that will allow a remote station to detect the retransmissions is to send such retransmissions at periodic intervals. In this method, a preamble is attached to the first transmitted subpacket, wherein the preamble carries information identifying which remote station is the target destination of the data payload, the transmission rate of the subpacket, and the number of subpackets used to carry the full amount of data payload. The timing of the arrival of subpackets, i.e., the periodic intervals at which retransmissions are scheduled to arrive, is usually a predefined system parameter, but if a system does not have such a system parameter, timing information may also be included in the preamble. Other information, such as the RLP sequence numbers of the data packet, can also be included. Since the remote station is on notice that future transmissions will arrive at specific times, such future transmissions need not include preamble bits.

Rayleigh fading, also known as multipath interference, occurs when multiple copies of the same signal arrive at the receiver in destructive manner. Substantial multipath interference can occur to produce flat fading of the entire frequency bandwidth. If the remote station is travelling in a rapidly changing environment, deep fades could occur at times when subpackets are scheduled for retransmission. When such a circumstance occurs, the base station requires additional transmission power to transmit the subpacket. This can be problematic if the residual power level is insufficient for retransmitting the subpacket.

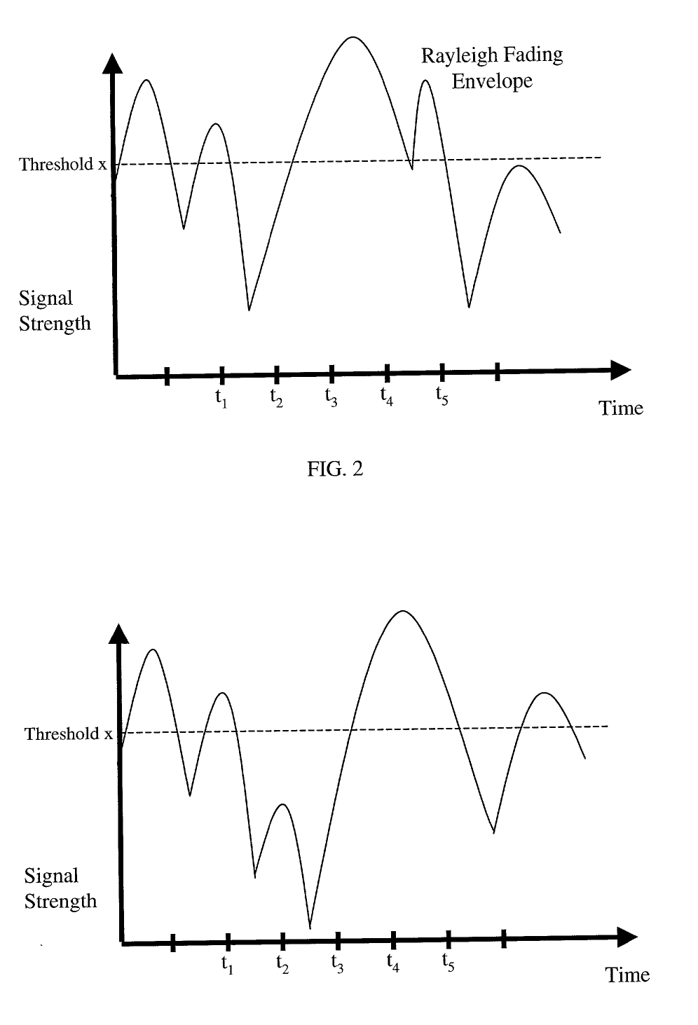

FIG. 2 illustrates a plot of signal strength versus time, wherein periodic transmissions occur at times t₁, t₂, t₃, t₄, and t₅. At time t₂, the channel fades, so the transmission power level must be increased in order to achieve a low FER.

Another method that will allow a remote station to detect the retransmissions is to attach a preamble to every transmitted subpacket, and to then send the subpackets during optimal channel conditions. Optimal channel conditions can be determined at a base station through information transmitted by a remote station. Optimal channel conditions can be determined through channel state information carried by data request messages (DRC) or by power strength measurement messages (PSMM) that are transmitted by a remote station to the base station during the course of operations. Channel state information can be transmitted by a variety of ways, which are not the subject of the present application. Such methods are described in U.S. patent application Ser. No. 08/931,535, filed on Sep. 16, 1997, entitled, “CHANNEL STRUCTURE FOR COMMUNICATION SYSTEMS,” assigned to the assignee of the present invention and incorporated by reference herein. One measure of an optimal channel condition is the Rayleigh fading condition.

The method of transmitting only during favorable channel conditions is ideal for channels that do not have predefined timing periods for transmissions. In the exemplary embodiment, a base station only transmits at the peaks of a Rayleigh fading envelope, wherein signal strength is plotted against time and the signal strength peaks are identified by a predetermined threshold value. If such a method is implemented, then an easily detectable and decodable preamble is vital for retransmissions. However, attaching preambles to every subpacket is problematic because the preamble bits are overhead bits that waste transmission power. For example, suppose that a preamble is K bits long, the data payload is divided into M subpackets, and the total number of bits for all subpackets is N. Then a periodic transmission that requires only one preamble will have an overhead of K/N bits and the amount of energy to transmit this overhead is 10log₁₀ (K/N). However, for aperiodic transmissions that require a preamble for each subpacket, the overhead is MK/N and the amount of energy to transmit this overhead is 10log₁₀(MK/N).

FIG. 3 illustrates a plot of signal strength versus time. If the base station determines that the signal strength to a remote station is good at times t₁, t₄, and t₅, but not at times t₂ and t₃ because the signal strength is not above threshold x, then the base station will only transmit at times t₁, t₄, and t₅.

In this embodiment, the decoding of retransmissions is dependent upon the detection and decoding of the preambles attached thereto. One method to ensure a low FER on the received preambles is to boost the transmission power level of the preamble bits. Another method is to transmit preamble messages on a separate channel from the retransmissions. For example, in some wireless communication systems, remote stations in the range of a base station are programmed to constantly scan an assigned channel for preamble messages. The remote stations are not programmed to periodically scan the data channels. If a preamble message targeted for a specific remote station arrives, the remote station is then aware that a data retransmission will be arriving at a specified time on a separate data channel, and will detect it accordingly. However, this method is still problematic in that if a preamble message is lost, then the data transmissions corresponding to the preamble message are also lost.

The exemplary embodiments described herein provide techniques for generating resilient preambles that still minimize the fractional overhead of the preamble bits in relation to the data payload.

In the exemplary embodiment, a method and apparatus for generating preamble subpackets is presented. In order to improve the resiliency and detectability of preamble information, the preamble information bits are spread to form a basic unit, whose elements are termed “chips.” The term “chips” refers to the output bits of a spreading function, wherein multiple spreading bits are used to represent a single data bit.

The basic preamble unit is repeated for a predetermined duration, and each repetition of the preamble unit is multiplied by either ‘−1’ or ‘+1.’ These operations upon the preamble information renders the preamble information more easily detectable and resilient. Table 1 shows a specific repetition and permutation pattern that accomplishes this purpose.

TABLE 1

| | 192-Chip | |
|---|---|---|
| Preamble | Preamble | |
| Length | Repetition | 192-Chip Preamble Sequence |
| (Chips) | Factor | Repetition Multiplication Pattern |
| 192 | 1 | −1 |
| 384 | 2 | +1, −1 |
| 768 | 4 | +1, +1, −1, −1 |
| 1,536 | 8 | +1, +1, +1, +1, −1, −1, −1, −1 |
| 3,072 | 16 | +1, +1, +1, +1, +1, +1, +1, +1, |
| | | −1, −1, −1, −1, −1, −1, −1, −1 |

In this specific example , the original preamble information is spread into a basic unit comprising 192 chips. Depending upon the transmission rate of the data subpackets, in which the accompanying data payload is packed, this basic 192-chip preamble unit is repeated according to the permutation/repetition pattern displayed in Table 1.

Henceforth, the total bits produced by any given repetition/combination of 192-chip preamble units will be referred to as a preamble package. Hence, every data subpacket that is transmitted in a channel sensitive manner, i.e., aperiodically, will have an attached preamble package.

Table 2 illustrates transmission of repeated preamble units with data subpackets. Each “D” indicates a subpacket carrying data payload and each “P” indicates a preamble unit of 192 chips. As shown, a pattern of an equal number of positive “P” and negative “P” together is easily detectable. Alternative permutation patterns are possible and fall within the scope of this embodiment.

TABLE 2

| | | | | | | | | | | | | | | | |
|---|---|---|---|---|---|---|---|---|---|---|---|---|---|---|---|
| D | D | D | D | D | D | D | D | D | D | D | D | D | D | D | D |
| −P | D | D | D | D | D | D | D | D | D | D | D | D | D | D | D |
| P | −P | D | D | D | D | D | D | D | D | D | D | D | D | D | D |
| P | P | −P | −P | D | D | D | D | D | D | D | D | D | D | D | D |
| P | P | P | P | −P | −P | −P | −P | D | D | D | D | D | D | D | D |
| P | P | P | P | P | P | P | P | −P | −P | −P | −P | −P | −P | −P | −P |

FIG. 4 is a diagram of an apparatus for generating the basic preamble unit and the repeated preamble pattern. Preamble information, including but not limited to information such as the remote station identifier, subpacket index, and subpacket transmission rate, is encoded at encoding element 40. Encoded information is input into a spreading generator 42 that produces the desired N-chip preamble unit. The N-chip preamble unit is then input into a mapping element 44 wherein the N-chip preamble unit is repeated and multiplied by +1 or −1 in accordance with a predetermined permutation pattern to produce a preamble packet.

Encoding element 40 can be a convolutional encoder with a constraint length K that produces N output bits for every M input bits, which produces an encoding rate of M/N. Alternatively, encoding element 40 can be a block coder or a Reed-Solomon encoder. Spreading element 42 can be any element configured to generate Y orthogonal output bits from X input bits.

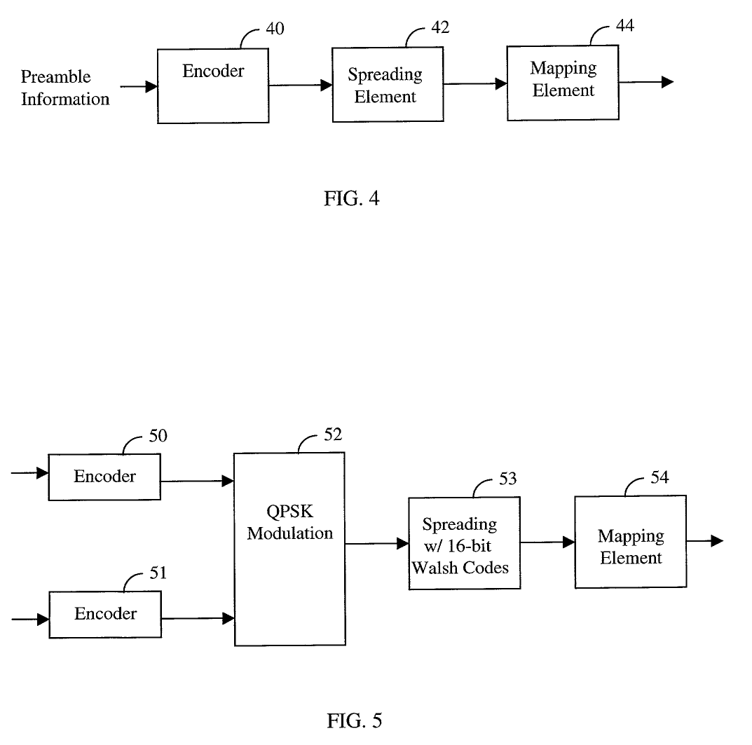

FIG. 5 is an apparatus for a more specific embodiment, wherein the remote station identifier is encoded separately from the rest of the preamble information.

Remote station identification bits, comprising 6 bits, are input into encoder 50 at rate 6/12. Other preamble information, comprising 4 bits, are input into encoder 51 at rate 4/12. 12-bit output of encoder 50 and 12-bit output of encoder 51 are input into a modulation element 52 to form in-phase (I) and quadrature (Q) components, wherein each bit from encoder 50 and each bit from encoder 51 are paired to create 12 values per original preamble information. I and Q components are spread using short 16 chip Walsh functions at spreading element 53 to form 192 values per original preamble information. The 192 chips are input into a mapping element 54 and are permuted in accordance with a predetermined pattern, such as the pattern shown in Table 1.

The apparatus in FIG. 5 has an advantage in that the remote station identifier bits are encoded separately from the other preamble information. Since the remote station identifier is separately encoded, a remote station need not decode the entire preamble in order to determine the identity of the intended recipient of the transmission.

In another exemplary embodiment, a method and apparatus for choosing the length of the preamble package is presented. A processor is configured to determine the number of subpackets needed to transport a data payload. Based upon the number of subpackets and the transmission rate of the subpackets, a preamble package size is chosen. Once the preamble package size is chosen, a fractional overhead of all preamble packages compared to the total bits is determined. If the fractional overhead is too large, then the processor repeats this analysis for a different number of subpackets.

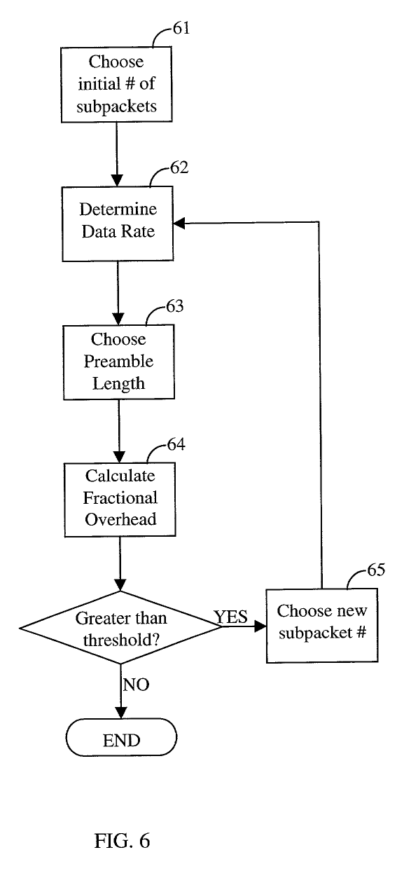

FIG. 6 is a flowchart illustrating the determination of subpacket preamble lengths by a processing element. At step 61, an initial value is chosen for the number of subpackets. The initial value can be set by channel conditions. For example, if the channel conditions are favorable, a high rate packet would probably be transmitted. For a high rate packet, a single subpacket carrying a large number of bits is used. Hence, the initial value would be 1. However, if the channel conditions are unfavorable, a low rate packet will probably to transmitted. For a low rate packet, multiple subpackets, each carrying a smaller number of bits, will be used. Hence, the initial value would be 4.

At step 62, a determination of the data transmission rate is made. At step 63, an estimate for the preamble package size is made. At step 64, the fractional overhead P/(N+P) is determined, wherein P is the size of all preamble packages attached to each data subpacket, and N is the total number of bits of the data subpackets. If the fractional overhead is larger than a threshold amount, then a new number of subpackets is chosen at step 65. The process flow returns to step 62 and the process is repeated until the fractional overhead is within a designated tolerance. Through experimentation, an optimal fractional overhead is less than 0.2500%.

In an alternative embodiment, a method and apparatus for using predetermined preamble lengths is presented. A processor, or scheduling unit, has predetermined preamble lengths, transmission rates, and number of subpackets stored in a look-up table in a memory element. Such a look-up table would store optimal preamble lengths that are known to be less than a fractional overhead amount at specific data rates and packet sizes. Table 3 is an example of a look-up table.

TABLE 3
(Using fourteen 16-chip Walsh Channels)

| | | | | | # of | # of | |
|---|---|---|---|---|---|---|---|
| | # of | # of | # of | Data | Subpacket | Subpacket | Preamble |
| Rate | Bits per | Subpackets | Slots per | Rate | Preamble | Preambles | Overhead |
| Index | Packet | per Packet | Subpacket | (kpbs) | Chips | per Packet | Fraction |
| 0 | 192 | 1 | 8 | 9.6 | 6144 | 1 | 0.2500 |
| 1b | 384 | 2 | 4 | 19.2 | 3072 | 2 | 0.2500 |
| 1a | 384 | 1 | 4 | 38.4 | 3072 | 1 | 0.2500 |
| 2b | 768 | 2 | 4 | 38.4 | 1536 | 2 | 0.1250 |
| 2a | 768 | 1 | 4 | 76.8 | 1536 | 1 | 0.1250 |
| 3d | 1536 | 4 | 2 | 76.8 | 768 | 4 | 0.1250 |
| 3c | 1536 | 3 | 2 | 102.4 | 768 | 3 | 0.1250 |
| 3b | 1536 | 2 | 2 | 153.6 | 768 | 2 | 0.1250 |
| 3a | 1536 | 1 | 2 | 307.2 | 768 | 1 | 0.1250 |
| 4d | 1536 | 4 | 1 | 153.6 | 384 | 4 | 0.1250 |
| 4c | 1536 | 3 | 1 | 204.8 | 384 | 3 | 0.1250 |
| 4b | 1536 | 2 | 1 | 307.2 | 384 | 2 | 0.1250 |
| 4a | 1536 | 1 | 1 | 614.4 | 384 | 1 | 0.1250 |
| 5d | 3072 | 4 | 1 | 307.2 | 192 | 4 | 0.0625 |
| 5c | 3072 | 3 | 1 | 409.6 | 192 | 3 | 0.0625 |
| 5b | 3072 | 2 | 1 | 614.4 | 192 | 2 | 0.0625 |
| 5a | 3072 | 1 | 1 | 1228.8 | 192 | 1 | 0.0625 |
| 6b | 3072 | 2 | 1 | 614.4 | 192 | 2 | 0.0625 |
| 6a | 3072 | 1 | 1 | 1228.8 | 192 | 1 | 0.0625 |
| 7b | 4608 | 2 | 1 | 921.6 | 192 | 2 | 0.0625 |
| 7a | 4608 | 1 | 1 | 1843.2 | 192 | 1 | 0.0625 |
| 8 | 3072 | 1 | 1 | 1228.8 | 192 | 1 | 0.0625 |
| 9 | 4608 | 1 | 1 | 1843.2 | 192 | 1 | 0.0625 |
| 10 | 6144 | 1 | 1 | 2457.6 | 192 | 1 | 0.0625 |

Table 3 illustrates an example of possible subpacket sizes, data rates, and preamble package sizes when fourteen 16-chip Walsh Channels are available to the base station. It should be noted that at any point of time, a base station only has a certain number of Walsh channels available for transmissions. The number of Walsh Channels will vary, and hence, the values for the parameters above in Table 3 will also vary.

Thus, a novel and improved method and apparatus for transmitting data traffic using optimized preamble structures have been described. Those of skill in the art would understand that the various illustrative logical blocks, modules, circuits, and algorithm steps described in connection with the embodiments disclosed herein may be implemented as electronic hardware, computer software, or combinations of both. The various illustrative components, blocks, modules, circuits, and steps have been described generally in terms of their functionality. Whether the functionality is implemented as hardware or software depends upon the particular application and design constraints imposed on the overall system. Skilled artisans recognize the interchangeability of hardware and software under these circumstances, and how best to implement the described functionality for each particular application. As examples, the various illustrative logical blocks, modules, circuits, and algorithm steps described in connection with the embodiments disclosed herein may be implemented or performed with a digital signal processor (DSP), an application specific integrated circuit (ASIC), a field programmable gate array (FPGA) or other programmable logic device, discrete gate or transistor logic, discrete hardware components such as, e.g., registers and FIFO, a processor executing a set of firmware instructions, any conventional programmable software module and a processor, or any combination thereof. The processor may advantageously be a microprocessor, but in the alternative, the processor may be any conventional processor, controller, microcontroller, or state machine. The software module could reside in RAM memory, flash memory, ROM memory, EPROM memory, EEPROM memory, registers, hard disk, a removable disk, a CD-ROM, or any other form of storage medium known in the art. Those of skill would further appreciate that the data, instructions, commands, information, signals, bits, symbols, and chips that may be referenced throughout the above description are advantageously represented by voltages, currents, electromagnetic waves, magnetic fields or particles, optical fields or particles, or any combination thereof.

Preferred embodiments of the present invention have thus been shown and described. It would be apparent to one of ordinary skill in the art, however, that numerous alterations may be made to the embodiments herein disclosed without departing from the spirit or scope of the invention. Therefore, the present invention is not to be limited except in accordance with the following claims.

What is claimed is:

1. A method for transmitting data packets in a wireless communication system in a channel sensitive manner, comprising:
repackaging a data payload into at least one subpacket;
generating at least one preamble payload, wherein the at least one preamble payload corresponds to the at least one subpacket; and
spreading the at least one preamble payload to form at least one preamble unit.

2. The method of claim 1, further comprising the step of sequencing the at least one preamble unit.

3. The method of claim 2, wherein the step of sequencing the at least one preamble unit is performed in accordance with a permutation pattern.

4. The method of claim 2, wherein the permutation pattern comprise:
repeating the at least one preamble unit for a predetermined repetitions; and
multiplying a portion of the at least one preamble unit by −1.

5. The method of claim 1, further comprising the step of encoding the at least one preamble payload, wherein the step of spreading the at least one preamble payload is performed upon an encoded preamble payload.

6. The method of claim 5, wherein a remote station identifier of the at least one preamble payload is encoded separately from a remaining portion of the at least one preamble payload.

7. The method of 5, wherein convolutional encoding is used in the step of encoding the at least one preamble payload.

8. The method of 5, wherein block coding is used in the step of encoding the at least one preamble payload.

9. The method of 1, wherein the step of spreading the at least one preamble payload uses a plurality of orthogonal codes.

10. The method of 9, wherein the plurality of orthogonal codes are Walsh codes.

11. A method for optimizing the transmission of a data payload on a wireless communication system, comprising:
choosing an initial number of subpackets, wherein each subpacket will carry a substantially similar copy of the data payload;
determining a data rate corresponding to the initial number of subpackets;
determining a length for a preamble package in accordance with the data rate;
determining a fractional overhead, wherein the length of the preamble package is compared to the bits of the subpackets;
if the fractional overhead is greater than a predetermined threshold amount, then choosing a new number of subpackets; and
if the fractional overhead is less than or equal to the predetermined threshold amount, then generating the preamble package.

12. The method of 11, wherein the step of choosing an initial number of subpackets uses channel conditions as a basis for choosing an initial number of subpackets.

13. A method for optimizing transmission of a data payload, comprising:
determining a data rate for the transmission of the data payload; and
using a look-up table to determine a corresponding packet size for the data payload and a preamble length, wherein the packet includes at least one subpacket and a preamble is attached to each of the at least one subpacket.

14. The method of 13, wherein the look-up table is one of a plurality of look-up tables, wherein each of the plurality of look-up tables correspond with a number of available Walsh channels.

15. An apparatus for generating a preamble for a data payload transmission, comprising:
an encoding element for receiving data payload transmission parameters;
a spreading element for receiving the encoded data payload transmission parameters and for spreading the encoded data payload transmission parameters; and
a mapping element for permuting the spread, encoded data payload transmission parameters.

16. The apparatus of claim 15, further comprising a modulation element for modulating the encoded data payload transmission parameters before input into the spreading element.

17. An apparatus for generating a preamble to a data packet, comprising a processor coupled to a processor-readable storage element containing an instruction set executable by the processor to:
repackage a data payload into at least one subpacket;
generate at least one preamble payload, wherein the at least one preamble payload corresponds to the at least one subpacket; and
spread the at least one preamble payload to form at least one preamble unit.

18. An apparatus for generating a preamble to a data packet, comprising:
means for repackaging a data payload into at least one subpacket;
means for generating at least one preamble payload, wherein the at least one preamble payload corresponds to the at least one subpacket; and
means for spreading the at least one preamble payload to form at least one preamble unit.

19. The apparatus of claim 18, further comprising means for sequencing the at least one preamble unit.

20. The apparatus of claim 18, further comprising means for encoding the at least one preamble payload.

21. An apparatus for optimizing the transmission of a data payload on a wireless communication system, comprising:
means for choosing an initial number of subpackets, wherein each subpacket will carry a substantially similar copy of the data payload;
means for determining a data rate corresponding to the initial number of subpackets;
means for determining a length for a preamble package in accordance with the data rate;
means for determining a fractional overhead, wherein the length of the preamble package is compared to the bits of the subpackets; and
means for deciding if the fractional overhead is greater than a predetermined threshold amount, then choosing a new number of subpackets; and if the fractional overhead is less than or equal to the predetermined threshold amount, then generating the preamble package.

22. An apparatus for generating optimized preamble structures, comprising:
means for storing a look-up table;
means for determining a data rate for a packet, wherein the packet includes at least one subpacket and a preamble is attached to each of the at least one subpacket; and
means for using the data rate for the packet to find a plurality of parameters on the look-up table, wherein the plurality of parameters include preamble lengths.
